(19) United States
(12) Patent Application Publication
(10) Pub. No.: US 2010/0316979 A1
(43) Pub. Date: Dec. 16, 2010

(54) DUMMY DEVICE, SYSTEM AND METHOD FOR PATIENT-BASED MEDICATION USING MEDICINAL AND/OR PHARMACEUTICAL AND/OR DIETARY SUPPLEMENT PRODUCTS FOR A PATIENT

(76) Inventor: Gottfried Von Bismarck, Hamburg (DE)

Correspondence Address: VENABLE LLP, P.O. BOX 34385, WASHINGTON, DC, 20043-9998, US

(21) Appl. No.: 12/528,579

(22) PCT Filed: Feb. 23, 2008
(86) PCT No.: PCT/EP08/01617

§ 371 Date: Aug. 25, 2009

(30) Foreign Application Priority Data
Feb. 26, 2007 (DE) 10 2007 009 652.8

(51) Int. Cl. G09B 19/00

(52) U.S. Cl. 434/127; 434/428

(57) ABSTRACT

The invention concerns a dummy device for patient-assisted medication with medical and/or pharmaceutical and/or food supplement products for a patient. The dummy device includes a pictorial representation, true to the original, of at least one real package detail containing the actual products. The dummy device is constructed and designed for interactive communication by at least one handling element. The invention further concerns a system using a dummy device and a method for patient-assisted control of medication with medical and/or pharmaceutical and/or food supplement products for a patient.

### CROSS-REFERENCE TO RELATED APPLICATIONS

This application is a National Stage Application of PCT/EP2008/001617, filed Feb. 23, 2008, which designates the United States and claims the priority of German patent application DE 10 2007 009 652.8, filed on Feb. 26, 2007.

### BACKGROUND OF THE INVENTION

The invention concerns a dummy device as well as a system for patient-assisted medication with medical and/or pharmaceutical and/or food supplement products for a patient. Furthermore the invention concerns a method for patient-assisted control of medication with medical and/or pharmaceutical and/or food supplement products for a patient.

“Medication” in the present application also means, besides the actual prescription of certain medical and/or pharmaceutical and/or food supplement products e.g., by a doctor or others, the manufacture or assembly, that is, content design, of the actual real package as well as the respective patient's actual behaviour of taking it. Furthermore, the patient's report of taking the medication and the clinical reaction to taking it form part of the medication. The medication, which in the broadest sense can also be regarded as drugs management, is individual for each person/patient. Apart from the type of illness, e.g., the physical and/or psychological properties and conditions as well as the personal way of life of a patient and various other factors play a part as well.

Drugs management as known and commonly applied hitherto includes several process steps, beginning with actual prescription of the medical and/or pharmaceutical and/or food supplement products (hereinafter also referred to generally as drugs) by a doctor, pharmacist or the like for a patient. Next the medication plan at issue is implemented by assembling a package in universally applicable form, in treatment-specific form or in patient-individual form. This package is made available to the patient. The actual taking of the medication as prescribed, which apart from the dose (e.g., X mg of active ingredient, two tablets or the like) of the drug also includes the time (morning, lunchtime, evening, after every meal, a particular time or the like) and the condition of taking it (e.g., take standing, take with plenty of water before a meal, do not take it together with another drug, or the like) as well as other conditions such as e.g., additional information on the instruction leaflet, is today controlled e.g., by verbal instructions by medical personnel, by the instruction leaflet, by SMS messages, by e-mails, by calls from a call centre, by video/voice messages and by various other media, channels, etc. Monitoring the correct or incorrect removal of the products from the package and taking of the products removed is possible only with great difficulty, as correct taking is almost exclusively subject to the patient's individual decision. Manual recording in an electronic dispenser is only one of several technical possibilities. But it is precisely keeping to correctly taking the prescribed medication, namely obedience in taking the drugs as prescribed, so-called patient compliance or adherence to the treatment, that is an essential factor for the course of the illness or treatment.

For indirect monitoring, e.g., to check removal, e.g., visual inspection or electronic monitoring of the package are possible, which however give little information about actual taking of the medication. Electronic monitoring is furthermore very tedious and expensive. Direct monitoring of actual taking of the medication is possible e.g., by so-called biomarkers, blood analyses or the like, and is particularly difficult and tedious. Usually the information is therefore passed on verbally. For the patient's reporting back to the prescribing doctor or the like on taking the medication, as a rule the patient file is used. In this case manual or electronic transmission can assist reporting. The clinical reaction, that is, the effect of the prescribed drugs as well as the resulting sensitivities of the patient, is usually established in the conversation in person or by telephone between patient and doctor (or nursing staff or the like).

It is, however, precisely in case of compliance as described above in taking the medication, particularly for the target group of chronically ill and/or multimorbid and/or older patients in home care or care in appropriate institutions, that the drugs management which is used in practice, that is, the so far known systems and methods of medication, shows considerable deficits. To put it another way, in particular the target group achieves typically low compliance values. As mentioned, however, low compliance values are a significant cause of poor course of illness, leading to re-admission to a hospital, increased mortality and high health costs. The methods and approaches which were common up to now for improving compliance are, as mentioned, expensive and require technical understanding, self-organisation and skill. Such qualities are present only to a limited extent particularly in the above-mentioned target group. Another drawback of the previous systems and methods lies in that the data and information pass through several interfaces, leading to an increased source of error. Another aspect which leads to the low compliance values lies in that patients see themselves as the subject of instructions of the doctor/nursing staff or the like. To put it another way, the one-way or single-track direction of the prescription from the doctor/nursing staff or the like to the patient leads to a feeling of “powerlessness” or “mental immaturity” in these patients, which additionally reduces the compliance values.

### SUMMARY OF THE INVENTION

It is therefore an object of the present invention to improve compliance in taking medical and/or pharmaceutical and/or food supplement products.

This object is achieved by a dummy device of the kind mentioned hereinbefore, the dummy device comprising a pictorial imitation, true to the original, of at least one real package detail containing the actual products, and the dummy device being constructed and designed for interactive communication by means of at least one handling element. As a result, for the first time is it at all possible to actively involve the patient in medication. Due to the imitation, true to the original, of the actual package which is (later) available to the patient, the recognition effect and hence acceptance is particularly high. Furthermore, the dummy device makes it possible in a particularly simple and cheap manner to produce an intensive exchange from the doctor to the patient on the one hand and from the patient to the doctor on the other hand. As a result, the compliance values increase considerably due to the two-way exchange of information. This not only applies to “normal” patients, that is, in particular the target group defined above. In clinical drugs research too, this leads to an increase in compliance values. In place of the doctor, naturally nurses or the like as well as any third parties may also be mentioned, particularly also packaging firms for drugs, distribution centres, hospitals, medical control centres, pharmacies or the like.

The dummy device may be constructed and designed for formation of the real package and/or for retrieval and/or entry of information concerning the medication by means of the real package by the patient. Due to the embodiment of the invention, any patient or nurse, family member or the like assisting him in his immediate environment can actively adapt or design the medication for his individual requirements and habits such as e.g., times and content of meals. Due to the fact that the patient is given a certain autonomy and a right to a say in determining actions, this leads to increased compliance. The interactive communication also allows the retrieval of information on the dummy device. For example, a crucial way to increase compliance lies in the intelligible, legible and/or individualised explanation of effects, side-effects, etc. of the drugs to be taken, which can be or is provided by the dummy device. A well-informed patient is more willing to take the drugs than an uninformed patient. Furthermore, the patient can also himself report information to the doctor through the dummy device. As an example one might mention information on the actual taking of medication, on the circumstances of taking it, on the effects of taking it, etc. This information in turn increases flexible prescription and the possibility of monitoring the medication.

In a further embodiment, the pictorial imitation may have dummy areas, each dummy area representing one product or several products defining a time for taking a product or a group of products. This creates a particularly clear arrangement which allows easy and reliable handling/operation.

Advantageously, each dummy area can be operated individually. Hence the information can be exchanged in measured quantities. This avoids overtaxing the patients with operation. Also, increased individualisation leads to even better compliance.

In another embodiment of the invention each dummy area representing at least one product may be allocated a reminder/alert signal which can be selected by operating the corresponding dummy area. Suitable reminder functions such as e.g., acoustic or optical signals, video messages which interrupt TV broadcasts, SMS or voice outputs can be selected or retrieved individually. Naturally, these reminder functions or instructions to take medication can also be extended to products for acute illnesses as well as e.g., to drips, syringes or ointments which are usually not contained in the (blister) packages.

The object may also be achieved by a dummy device being obtainable by software which can be run on a computer unit. With little expenditure this allows implementation in all electronic units common at the time, such as e.g., TV, PC, PDA, mobile telephone, etc., so that the dummy device can be used flexibly without being tied to a place.

The object may further be achieved by a system of the kind mentioned hereinbefore, the system comprising at least one medication device with a first transmitting/receiving device as well as with an input unit and a display unit for information and/or data relating to medication, and at least one patient device with a second transmitting/receiving device, a display unit as well as with a dummy device representing a pictorial imitation of at least one real package detail containing the actual products, and with at least one handling device for operating the dummy device, the medication device and the patient device being functionally connected by means for the electronic two-way exchange of information and/or data.

The object may also be achieved by a method of the kind mentioned hereinbefore, in which a pictorial imitation, true to the original, of at least one real package detail containing actual products is provided to the patient by means of a dummy device by a remotely located medication device, and interactive two-way data exchange with respect to the medication is carried out between the two devices by means of a transmitting/receiving device of a patient device that can be handled by the patient through the dummy device, and by means of the medication device comprising a transmitting/receiving device.

The advantages arising from the system and method according to the invention have already been described in connection with the dummy device. To avoid repetition, reference is therefore made to the corresponding passages.

### BRIEF DESCRIPTION OF THE DRAWINGS

Further advantageous and/or appropriate features or developments are apparent from the subsidiary claims and the description. Additional embodiments are described in more detail with the aid of the attached drawings. The drawings show:

FIG. 1 is one embodiment of a top view of a dummy device, comprising a pictorial representation of a patient-individual package, the dummy device being shown on a display unit;

FIG. 2 is an embodiment of a top view of the view as in FIG. 1 with interactions by way of examples;

FIG. 3 is an embodiment of a schematic view of a system according to the invention with a medication device and a patient device;

FIG. 4 is an embodiment of a schematic view of an actual, real patient-individual package; and

FIG. 5 is an embodiment of a top view of a traditional, treatment-specific real blister package.

### BRIEF DESCRIPTION OF THE EMBODIMENTS

The dummy device described as well as the corresponding system and the method are used for patient-assisted and patient-individual medication with medical and/or pharmaceutical and/or food supplement products of patients. Naturally the devices, systems and methods can also be used specifically to the treatment or in case of universal medication.

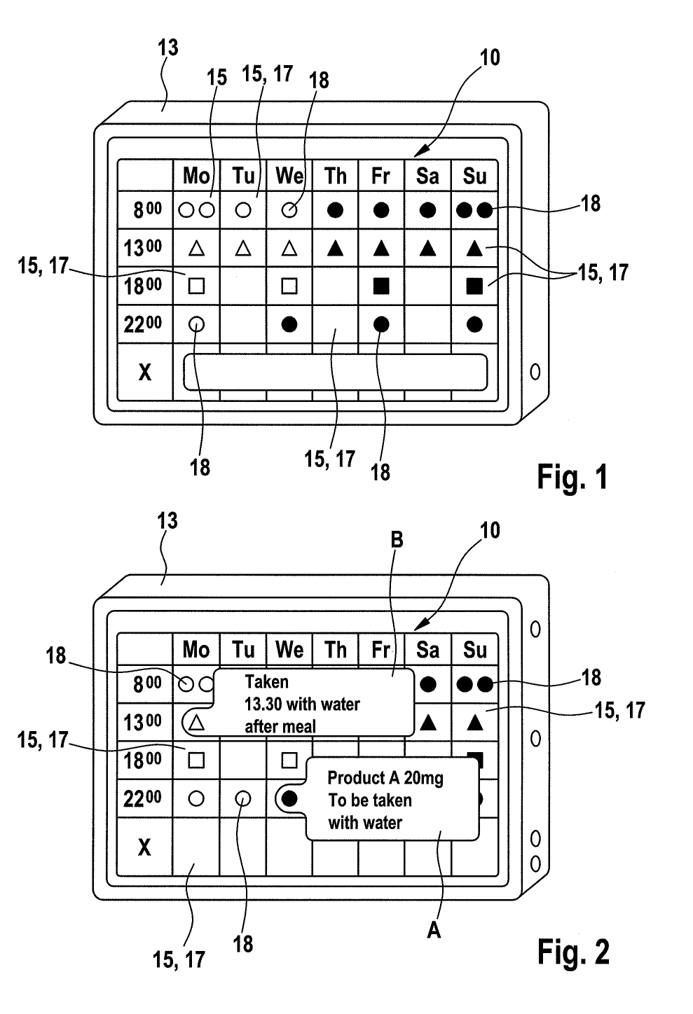

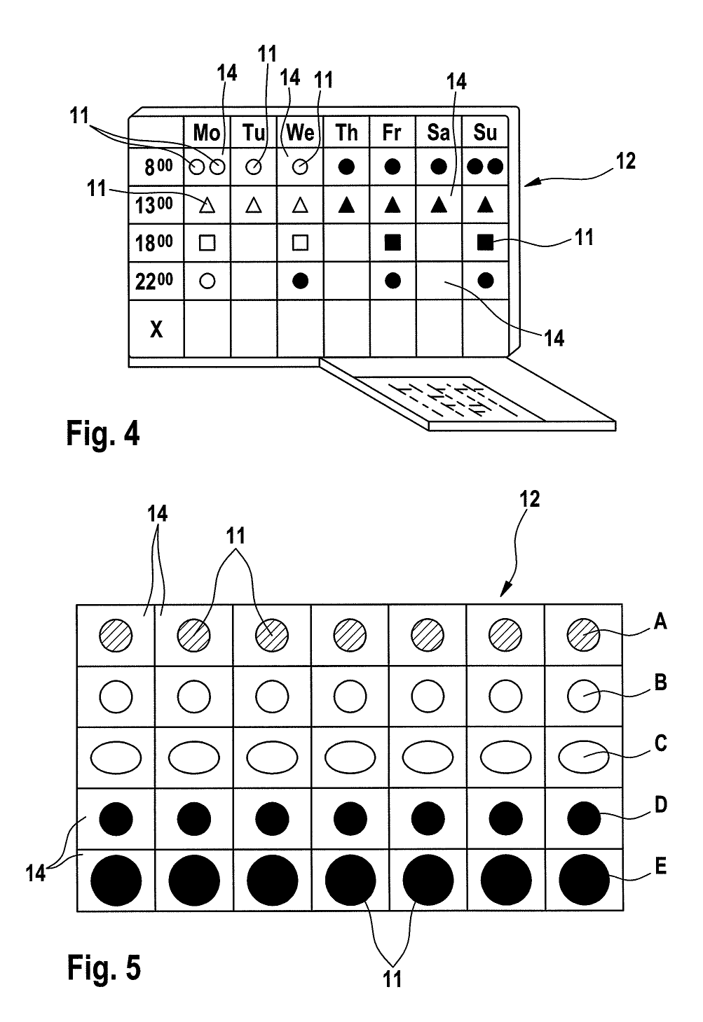

In FIG. 1 is shown a dummy device 10 which may be defined by a pictorial imitation, true to the original, of a real package detail of the package 12 shown in FIG. 4 containing the actual products 11. The pictorial imitation can be displayed on any available display unit 13. Purely as an example, a television set (TV), a personal computer (PC), a personal digital assistant (PDA), a mobile telephone or the like are mentioned as the display unit 13.

Real packages 12 may be constructed like a matrix in two dimensions and have rows and columns. In FIG. 4 is shown a patient-individual package 12 which is designed as a so-called one-week blister, and in the columns are shown the weekdays and in the rows the respective times of taking medication on the corresponding weekday. Naturally, other divisions and blister arrangements as well as other types of package are possible. An example of this can be found in FIG. 5, in which the package 12 has five rows, with drug A arranged in the first row, drug B in the second row, drug C in the third row, drug D in the fourth row and drug E in the fifth row. Such packages 12 are assembled specifically for the treatment, compared with the patient-individual package 12 as in FIG. 4. The packages 12 shown are selected purely as examples and can be replaced by any other packages. The matrix forms areas 14 which can also be referred to as compartments or recesses. In each area 14 can be arranged one product 11 (see e.g., Tues, 08.00 hours in FIG. 4) or several products 11 (see Mon, 08.00 hours in FIG. 4).

The dummy device 10 as in FIG. 1 may be an identical pictorial representation e.g., of the package 12 shown in FIG. 4 or the relevant detail of it. The dummy device 10 is further constructed and designed for interactive communication by means of at least one handling element. For this purpose the pictorial representation has dummy areas 15 which correspond to the areas 14 of the real package 12. Each dummy area 15 which has a pictorial representation 18 of one product 11 or of several products 11 defines a time for taking a product 11 or a group composed of several products 11. For two-way communication, each dummy area 15 provided with a pictorial representation of at least one product 11 can be addressed or opened. Free dummy areas 15 too can be capable of being addressed or opened. In other words, each dummy area 15 can be operated individually by activating it by means of the one or more above-mentioned handling elements 16. All the usual available devices are possible as the handling element 16, such as e.g., a remote control for a TV, a touch screen, a mouse, a stylus or the like. Hence the dummy device 10 is suitable for assisting two-way exchange of data/information. Expressed in pictures, the dummy area 15 can be opened like a compartment in order to put data/information in the compartment or take data/information out of the compartment. In other words the dummy device 10 is therefore constructed and designed for formation of the real package 12 and/or for retrieval and/or entry of information concerning the medication by means of the real package 12 by the patient. The pictorial representation of the imitation of a real package 12 including the dummy areas 15 allocated and capable of operation is therefore understood to be the basic form of the dummy device 10 according to the invention. The display unit 13 and the or each handling element 16 are only means for the purpose and not part of the basic form of the dummy device 10.

Each dummy area 15 is allocated a control area 17 which can be operated by the or each handling element 16, the control area 17 may be represented by the dummy area 15 itself. But in other embodiments each dummy area 15 can also be allocated a separate window or the like as the control area 17, which is designed for the entry and retrieval of data/information. Also the dummy window 15 can be allocated a menu guide by means of which the patient can select the desired function, e.g., entry of information or retrieval of information or the like. For this purpose, each dummy area 15 having at least one pictorial representation 18 of a product 11 may be allocated information which can be retrieved by operation, that is, e.g., clicking on, activation, opening, touching or the like of the corresponding dummy area 15. In one embodiment, the dummy area 15 may be allocated lists of different content by means of which the medication can be influenced. Furthermore, each dummy area 15 having at least one pictorial representation 18 of a product 11 may be allocated an acknowledge function for acknowledgement of taking the or each real product 11 of the area 14 of the real package 12 corresponding to the dummy area 15, which can be triggered by operation of the corresponding dummy area 15.

Each dummy area may have at least one pictorial representation 18 of a product 11 which may be further allocated a reminder/alert signal. The reminder/alert signal can be selected individually from a list allocated to the dummy device 10 or to each dummy area 15, or is freely programmable. Selection or programming can be carried out by operation of the dummy area 15. This function is in particular assisted by the fact that the dummy device 10 is obtainable optionally by software which can be run on a computer unit. In other words, the dummy device 10 may comprise a program module for extension of the above-mentioned basic form. This program module can be integrated in any electronic equipment.

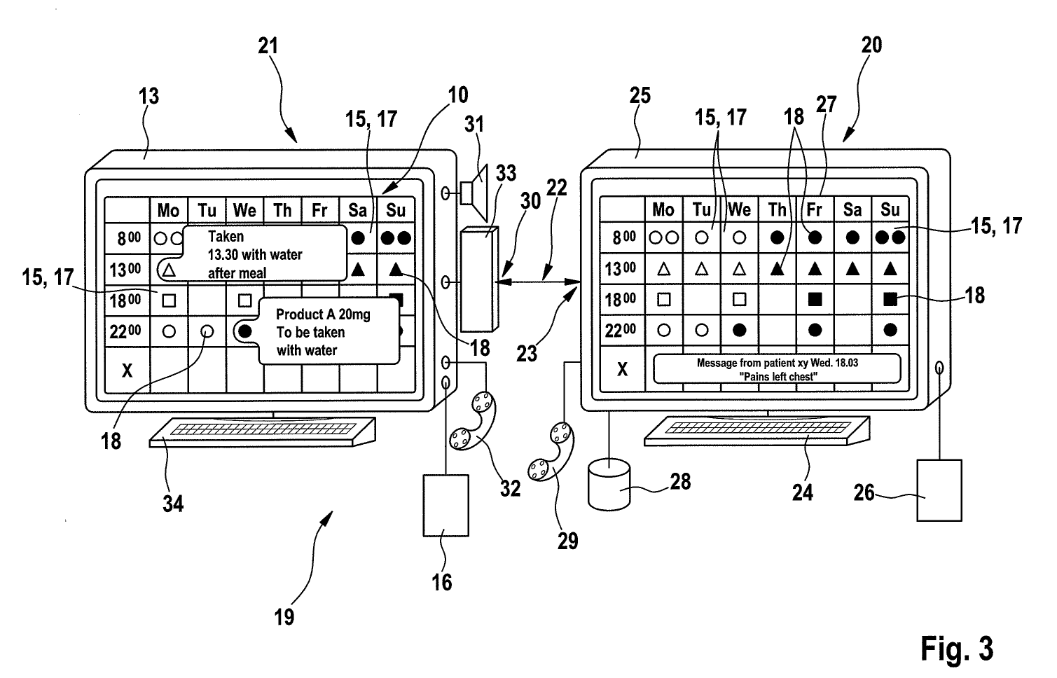

A system 19 for patient-assisted control of medication can be seen in FIG. 3. The system 19 is shown purely by way of example and not limited to the concrete embodiment. It comprises a medication device 20 which maybe provided in a doctor's practice, at a pharmacy, in a call centre, in a health centre, in a hospital, but also at a manufacturer's for packages, in a logistics centre or the like, and a patient device 21 which may be provided to the patient, the assisting nurses or the like. The medication device 20 and the patient device 21 can be functionally connected by suitable means 22 such as e.g., the internet, video or TV channels or the like. The means 22 may be constructed and designed for the two-way electronic exchange of information and/or data.

The medication device 20, which may be allocated to the expert side and can also be referred to as the sender device, has at least one transmitting/receiving device 23, an input unit 24 and a display unit 25. The input unit 24 serves to enter the data and/or information and can be e.g., a keyboard or the like. The input unit 24 is also allocated a handling or control element 26 which can be an ordinary mouse. But a touch screen, stylus or the like can also be used as the control element 26. The display unit 25 serves to display the data and/or information. Existing devices such as e.g., the display on the PC or on the laptop or on a production machine or the like can be used as the display unit 25. However, a separate device exclusively for the purpose is possible too. The medication device 20 may also include a device 27 which provides a picture, true to the original, of a package which is to be filled and is filled according to prescribed medication, the picture being displayed on the display unit 25 of the medication device 20. Basically, the device 27 therefore also shows a dummy device as described above. Optionally, the medication device 20 is allocated at least one storage element 28 for the storage of patient-individual data as well as additional information on prescribed medical and/or pharmaceutical and/or food supplement products. Additional means of communication 29 too, which are shown only by symbols in FIG. 3, can be connected to the medication device 20 or be an integral part.

The patient device 21, which may be allocated to the patient and can also be called the receiver device, likewise has at least one corresponding transmitting/receiving device 30, a corresponding display unit 13 and a handling or control device 16. In addition a dummy device 10 which may be constructed and designed in the manner described above forms part of the patient device 21. Further accessory or supplementary modules can also be connected to the patient device 21 or be an integral part of it. Purely as an example, a loudspeaker 31, an additional means of communication 32 and an input unit 34 are shown. At least one of the two devices 20 or 21 may be allocated a coding/decoding module 33 which protects the personal or patient-related data and information.

The dummy device 10 may be composed of a program unit. The same applies to the device 27. Thus implementation in the patient device 21 or the medication device 20 can be carried out in a particularly simple manner. The program unit of the dummy device 10 may be identical with the program unit of the device 27. It is therefore possible to provide the dummy device 10 or the device 27 independently of equipment, which in particular also allows integration in existing equipment such as e.g., a TV set, a PC, a mobile telephone or the like.

Below, the method is described in more detail with the aid of the figures by the example of a patient-individual package.

Before a real package 12 as shown in FIG. 4 is actually made or produced, a pictorial imitation, true to the original, of at least one real package detail containing the actual products 11 is made available to the recipient/patient by means of the dummy device 10. For this purpose the imitation of the detail of the package showing all products of e.g., a one-week package is produced or provided 1:1 by a doctor or the like in the medication device 20, and transmitted from the latter to the patient device 21. The imitation can also be provided by the medication device 20 and retrieved by the patient. The display of the imitation of the real package 12 is then shown on the display unit 13, so that recipient (e.g., patient) and sender (e.g., doctor) have the identical picture of the medication prescribed and planned by the doctor.

In the event that the patient would like to influence the medication directly, the patient can optionally give his consent and/or ask for an individual adaptation (e.g., on the basis of certain habits) or do these himself. This may be for example the instruction that basically breakfast is dispensed with, so that medication cannot be taken in the morning at 08.00 hours with breakfast. For interactive adaptation, the patient uses the respective dummy area 15 for which he wants an adaptation, e.g., by means of the handling device 16. As a result there is a two-way interactive exchange of data between patient device 21 and medication device 20, by the transmitting/receiving device 30 of the patient device 21, which can be handled by the patient through the dummy device 10, and the transmitting/receiving device 23 of the medication device 20. In other words, the patient device 21 transmits data/information to the medication device 20, the data/information representing the reporting data of the patient who operates the dummy device 10, and being provided in the medication device as a basis for further/altered medication. The exchange of data is continued until correspondence is obtained between doctor and patient. It is basically possible for the patient to intervene in the pictorial representation 18 via the dummy device 10 for formation of the actual package 12, and e.g., remove or add representations 18 of products. For this purpose as for the whole of the preceding description, an assistant, nurse, family member or the like can be named instead of the patient. But the reporting data can also be simple acknowledgements of taking the products 11. The actual values of taking the medication can be reported back to the medication device 20 by means of the dummy device 10, if need be with different times and/or conditions of taking it (see e.g., area B in FIG. 2). The acknowledgement and/or adaptation requests and/or all other data/information are stored by the medication device 20 in an individual patient file. Optionally, an evaluation of the data/information can be made and reported back to the patient in a correcting and/or rewarding or reinforcing manner by pictorial, voice or other message.

The medication device 20 may transmit data/information on medication to the patient device 21 at the request of the patient, e.g., triggered by a click with the cursor on a dummy area 15 or by entry via the input unit 34. As an example, the information “product A 20 mg, to be taken with water” may be provided in a dummy area 15 in FIG. 2 (see window A in FIG. 2) at 22.00 hours on Wednesday. Hence individual provision of information according to requirements in both directions, that is, doctor to patient and patient to doctor, may be guaranteed. The information, which may include e.g., detailed safety instructions as well (such as e.g., with an empty stomach, half an hour before breakfast), may be shown with improved legibility or prepared individually.

Times and/or circumstances of taking the individual products 11 may be indicated by means of the dummy device 10 (see again e.g., window A, also messages or the like that interrupt TV broadcasts may serve as an example) and displayed for acknowledgement by the patient. The acknowledged data/information in turn may be transmitted from the patient device 21 to the medication device 20 and stored there. The dummy device 10 may in this case also be used as a platform for instructions on entry or taking of other products such as e.g., products for acute illnesses or for drops, syringes, ointments, changes of dressing or the like.

The dummy device 10 and its connection to the system 19 may allow an intensive monitoring function both on the sender side (doctor, hospital, etc.) and on the recipient side (patient, family members, etc.). Thus, for example, the patient can at any time forward the clinical reaction to the medication and the individual sensitivity via the dummy device 10 to the medication device 20. The dummy device 10 or the patient device 21 allows the patient to communicate with the doctor continuously, this being at the optimum time chosen by the patient himself in a pleasant and familiar environment. In reaction the doctor may at any time monitor the process, the progress of treatment or the medication and adapt or break it off at short notice and individually.

It is evident from the description that the dummy device 10 can be constructed as an information and/or design portal. It is mainly the patient and the doctor who have been mentioned as recipient and sender. This choice was made purely as an example and can of course be replaced by other persons, institutions or the like. Apart from the conventional target group, the invention in particular also supports the compliance-sensitive area of clinical drugs research.

1-22. (canceled)

23. A method for patient-assisted medication with medical, pharmaceutical, or food supplement products for a patient, comprising:
creating, with use of an electronic dummy device, a pictorial imitation, true to the original, of at least one real package detail containing actual products; and
providing, by at least one electronic handling device, interactive communication between the dummy device and the patient for exchange of information between the patient and the dummy device.

24. The method of claim 23, wherein the at least one package detail created with the dummy device comprises a pictorial imitation of a real product package;
and the providing step includes at least one of retrieving medicinal information and entering medicinal information utilizing the pictorial imitation of the real product package.

25. The method of claim 23, wherein the pictorial imitation of the real product includes at least one dummy area and the method further includes:
representing, in the at least one dummy area, at least one product and defining a time for taking the at least one product.

26. The method of claim 25, wherein the at least one dummy area comprises at least two dummy areas which are operable independently of each other.

27. The method of claim 25, wherein the at least one dummy area is allocated a control area which is operable through the at least one electronic handling device.

28. The method of claim 27, wherein the control area is represented by the at least one dummy area.

29. The method of claim 25, further comprising:
generating a reminder or an alert for each of the at least one dummy area representing at least one product, wherein the reminder or alert is retrievable by operating the at least one dummy area.

30. The method of claim 25, wherein the at least one dummy area is allocated information which is retrievable by the patent.

31. The method of claim 25, wherein the at least one dummy area is allocated an acknowledgement function for acknowledging actual taking of the at least one product, wherein the acknowledgement function is triggered by the at least one dummy area.

32. The method of claim 23, wherein the pictorial representation comprises a pictorial imitation, true to the original, of a patient-individual package.

33. The method of claim 23, wherein the dummy device comprises:
a computer unit; and
machine instructions executable on the computer unit operative to display the pictorial imitation, true to the original, of at least one real package detail.

34. A system to assist a patient with medical, pharmaceutical, or food supplement products comprising:
at least one medication device comprising:
a first display device,
an input device coupled to the first display device, and
a first transmitting and receiving device, coupled to the first display device; and
at least one patient device comprising:
a mechanism to generate a first dummy device representing a pictorial representation, true to the original, of at least one detail of a real package containing the actual products to assist a patient with medical, pharmaceutical, or food supplement products,
a second display device operative to display the first dummy device,
at least one handling device coupled to the second display device, the at least one handling device operative to control the first dummy device,
a second transmitting and receiving device coupled to the second display device
wherein the medication device and the patient device are coupled for electronic two-way exchange of information or data.

35. The system to assist a patient of claim 34, wherein the at least one medication device further includes a second mechanism to generate a second dummy device representing a pictorial representation, true to the original, of at least one prescribed medication package to assist a patient with medical, pharmaceutical, or food supplement products, and the first display device is operative to display the second dummy device representing a pictorial representation true to the original of the prescribed medication package.

36. The system to assist a patient of claim 34, wherein the medication device further comprises:
at least one storage device coupled to the first display device, wherein the storage device is adapted to store at least one of:
patient-individual files,
information on prescribed medical products,
information on pharmaceutical products, and
information on food supplement products.

37. The system to assist a patient of claim 34, wherein the mechanism to generate the first dummy device comprises a programmable unit.

38. The system to assist a patient of claim 34, wherein the mechanism to generate the second dummy device comprises a programmable unit.

39. The system to assist a patient of claim 34, wherein the first display device comprises a component of:
a television set,
a computer,
a personal digital assistant, or
a mobile telephone.

40. The system to assist a patient of claim 34, wherein the second display device comprises a component of:
a television set,
a computer,
a personal digital assistant, or
a mobile telephone.

41. The system to assist a patient of claim 34, further including a coding and decoding module coupled to at least one of the patient device or the medication device, wherein the electronic two-way exchange of information or data between the medication device and the patient device is protected through the coding and decoding module.

42. A computer-implemented method for patient-assisted control of medication with medical, pharmaceutical or food supplement products for a patient comprising:
transmitting from a medication computer a pictorial representation, true to the original, of at least one real product package detail containing actual products, wherein the transmitting is performed using a first transmitting and receiving device;
receiving on a patient computer the pictorial representation, true to the original, of the least one real product package detail containing actual products from the medication computer, wherein the receiving is performed using a second transmitting and receiving device;
displaying on a dummy device of the patient computer the pictorial representation, true to the original, of the least one real product package detail containing actual products; and
exchanging interactive two-way data or information between the medication computer and the patient computer, wherein the exchanging is performed using the first transmitting and receiving device and the second transmitting and receiving device.

43. The computer-implemented method of claim 42, further comprising:
transmitting data or information from the patient computer to the medication computer, wherein the data or information comprises reporting data of a patient who operates the dummy device; and
altering at least one medication of the patent based on the reporting data.

44. The computer-implemented method of claim 42, further comprising:
transmitting data or information on at least one medication of the patient from the medication computer to the patient computer at the request of the patient.

45. The computer-implemented method of claim 42, further comprising:
displaying on the dummy device of the patient computer at least one of:
times for taking at least one medication of the patient, or
circumstances for taking the at least one medication of the patient;
transmitting an acknowledgement that the at least one medication of the patient has been taken by the patient from the patient computer to the medication computer; and
receiving and storing the acknowledgement on the medication computer.

46. The method of claim 23, further comprising:
providing two-way exchange of data or information between an electronic medication device and the dummy device.

47. The method of claim 46, wherein the medication device includes a display device which provides a pictorial representation, true to the original, of at least one prescribed medication package to assist a patient with medical, pharmaceutical, or food supplement products.

48. The method of claim 46, further comprising:
storing on the medication device at least one of:
patient-individual files,
information on prescribed medical products,
information on pharmaceutical products, and
information on food supplement products.

49. The method of claim 46, wherein the dummy device comprises a programmable unit.

50. The method of claim 46, wherein the medication device comprises a programmable unit.
